(19) United States
(12) Patent Application Publication
(10) Pub. No.: US 2015/0346721 A1
(43) Pub. Date: Dec. 3, 2015

(54) AIRCRAFT

(71) Applicant: Aibotix GmbH, Kassel (DE)

(72) Inventors: Carsten WERNER, Kassel (DE); Uwe CHALAS, Breuna (DE)

(21) Appl. No.: 14/292,653

(22) Filed: May 30, 2014

(51) Int. Cl. G05D 1/00; G05D 1/04; B64C 39/02; G05D 1/08

(52) U.S. Cl. CPC G05D 1/0016; G05D 1/0808; G05D 1/042; B64C 39/024; B64C 2201/024; B64C 2201/128; B64C 2201/146

(57) ABSTRACT

A flight system comprising an aircraft equipped with at least four rotors and having a payload, a number of rotors rotating in one direction and a number of rotors rotating in the other direction, as well as a remote control, the aircraft being connected to the remote control, so as to transmit data, via respective transmitter/receiver units, both the aircraft and the remote control having a data processing device connected to the respective transmitter/receiver unit, both the aircraft and the remote control having the same sensors for flight attitude detection, where, when there is an angle change in the remote control around its X- and/or Y- and/or Z-axis, the amount of the angle change correlates with a definable speed of the aircraft, the speed specified according to the angle change being transmitted as a target value of the data processing device of the aircraft and/or of the remote control.

### BACKGROUND

The invention relates to a flight system comprising an aircraft equipped with at least four rotors and having a payload, a number of rotors rotating in one direction and a number of rotors rotating in the other direction, as well as a remote control.

Flight systems of the aforementioned type are known in the form of toys, the range of the aircraft being extremely limited, the aircraft sometimes even being allowed to fly only within enclosed spaces. The range of the remote control for controlling the flight movements is limited just as the flight altitude of the aircraft. Flight systems with aircraft that serve commercial purposes differ from this.

Such flight systems likewise comprise an aircraft and a remote control, the aircraft being able to accommodate a payload, e.g. a camera. The flight system is equipped such that the range of the aircraft, also called a helicopter, is only limited by the range of the transmitter and receiver unit. The altitude, to which such type of aircraft can climb, may be up to several hundred meters.

### SUMMARY

This means that, in complete contrast to the toy sector, in which such aircraft may only achieve an altitude of about 3 to 5 m and are only flown at close range, i.e. at a distance of from 20 to 30 m, a flight system that is intended to serve commercial purposes is thus presented with completely different requirements. This relates not only to the question of the performance of the transmitter and receiver units but also to the question of the controllability of such a helicopter. The helicopter, which has at least four rotors, of which a few rotate in one direction and the others rotate in the other direction, must in this case be controllable in the form that information that is specified on the remote control for the helicopter regarding the flight attitude and speed is precisely adopted on the helicopter. This means, it must be ensured that the target data to be set on the remote control for the helicopter be converted one-to-one by the drive system of the helicopter.

A flight system is described that is capable of converting the information specified by the remote control directly one-to-one and particularly with respect to speed and direction. The described flight system, however, is not capable of converting the target values specified by the remote control into actual values of the aircraft in an essentially identical manner but rather beyond that is also capable of intuitively piloting the aircraft by swiveling the remote control around the X-, Y-, and Z-axes. This means that the movements of the remote control experience directly their equivalent in the movement of the aircraft. To this end, it is necessary that both the aircraft as well as the remote control have corresponding sensors for detecting the flight attitude, for example, accelerators and gyroscopes. Both the accelerators and gyroscopes, three of each being preferably provided in both the remote control and the aircraft, are each aligned in the direction of an axis in the Cartesian coordinate system. In this context, reference is made to the following: It would be theoretically conceivable to determine the flight attitude of the helicopter with even three accelerators and one gyroscope. The precision of determining the flight attitude is significantly increased, however, if three gyroscopes are provided in addition to the three accelerators. The gyroscopes and the accelerators represent an IMU (Initial Measurement Unit). This IMU enables the determination of translational and rotational movements. In order to undertake a measurement in all three spatial directions, preferably three-axis sensors are used, whose three axes are oriented orthogonally with respect to one another. The determination of the flight attitude by a so-called IMU unit is an essential prerequisite for being able to fly the helicopter via the remote control. In this context, a provision is that the data processing devices of both the helicopter and advantageously the remote control have a control. Thus, according to an advantageous feature of the invention, the control is implemented in the data processing device of the aircraft.

This means that both the control of the speed as well as the flight direction take place after the defined values are received via the remote control in the aircraft's data processing device. This has the advantage that the aircraft reacts substantially faster than in an embodiment in which the control for the aircraft would be implemented in the remote control. However, the control in the data processing device requires significant computing capacity, which means additional weight, which, in turn, can lead to the control being placed in the remote control if there is a correspondingly weaker drive performance for the aircraft; i.e., the processing of the data takes place in the data processing device of the remote control. However, this also means that the data for determining the actual speed of the helicopter over ground, which is determined, for example by means of GPS, radar sensors, or a visual method such as the “optical flow method,” will be transmitted just as the data for the flight attitude detection from the helicopter to the data processing device of the remote control, in which the data processing device of the remote control calculates the values required for the control for thrust and flight attitude through a target-actual comparison, and transmits the calculated thrust and flight attitude values for the data processing device of the aircraft, the data processing device of the aircraft converting these specifications for the flight attitude and thrust into the required rotational speeds of the individual rotors. In this context, reference should be made to the following:

A helicopter comprising a housing having at least four rotors, but preferably six rotors, in order to fly in a direction is tilted accordingly in this direction. This means that individual rotors on the helicopter operate slower than other rotors, the speed of the rotors, however, being controlled in this flight attitude to generate the required thrust. This means that when the tilt angle of the remote control is a variable for the speed of the helicopter, the speed values defined according to the tilt angle are stored in the data processing devices for the helicopter as well as the remote control. In this respect, the helicopter can be piloted through by moving the remote control around the x- and y-axes in the corresponding direction. However, this also means that, as has been previously explained, both the helicopter and the remote control have a corresponding coordinate system.

According to a further feature of the invention, it is provided that the helicopter be able to rotate around its own axis. In order to determine the rotational speed as the actual speed, the gyroscopes in this case are used in particular as flight attitude sensors. It is also true in this case that the change in the angular position of the remote control around the z-axis represents a variable for the rotational speed of the aircraft around its own axis.

According to a further feature of the invention, the data processing device has an attitude control for aligning the aircraft in the horizontal position that is connected to the sensors for flight attitude detection and to the rotors. Mention has already been made of the fact that the aircraft will serve commercial purposes including, among other things, recording images and even moving images, e.g. in the form of a video, using a camera arranged underneath the aircraft. To do this, it is necessary for the aircraft to be held as still as possible also in order to give the camera the ability to focus on an object. In order to implement such position control, particularly in the horizontal position, the sensors for the flight attitude detection, namely the previously mentioned accelerators and gyroscopes, are also used. The control is implemented specifically by controlling the rotational speed of the individual rotors.

A further special feature of the invention provides that the sensors for flight attitude detection be supplemented by at least one magnetometer, i.e., such a magnetometer as a compass makes it possible to determine the degree of deviation in the alignment of the magnetometer toward the north.

The deviation can then be determined again in all three spatial directions, a sufficiently precise alignment of the aircraft being possible in combination with the previously mentioned accelerators and gyroscopes, particularly through the interaction between the gyroscopes, the accelerators, and the at least one magnetometer. In order to determine the flight attitude of the aircraft, the gyroscopes and accelerators in the aircraft and in the remote control, as previously shown, form a so-called IMU (Inertial Measurement Unit). This is how the rotational and translational movements are determined. In order to measure in all three spatial directions, so-called three-axis sensors are provided as gyroscopes and accelerators that have three sensitive axes oriented orthogonally with respect to one another. The accuracy of the determination of the flight attitude can ultimately be increased even more by including also the data of a three-axis magnetometer. A system such as this, comprising both a magnetic sensor to determine the angular attitude and gravitation as well as gyroscopes and accelerators, are known in the prior art as MARG systems (MARG=Magnetic Angular Rate and Gravity). Such MARG systems are capable of carrying out complete determination of the orientation of the aircraft or of the remote control relative to the direction of gravitation of the magnetic field of the earth.

Reference is made to the following publication in this context:

An efficient orientation filter for inertial and inertial/magnetic sensor arrays, Sebastian O. H. Madgwick, Apr. 30, 2010.

According to a further feature of the invention, the remote control itself is designed with a touchscreen monitor as an input and display device. In this respect, using this touchscreen monitor, i.e. using the input device, the rates of ascent and/or descent, for example, may be defined. This means, particularly with respect to the rate of descent of the aircraft, that it will not exceed a certain value starting from a certain minimum altitude above ground ultimately in order to prevent the aircraft from crashing into the ground. In this regard, the aircraft also has sensors for determining the altitude that are implemented, for example, as ultrasound sensors and as sensors for determining the air pressure. Ultrasound sensors in this case function satisfactorily up to altitudes of about 5 to 10 m above ground, while air pressure sensors, on the other hand, function in ranges that are above those of the ultrasound sensors, a certain overlapping range being necessary in order to present a precise measurement in any situation.

According to a further feature of the invention, the aircraft has lateral distance sensors in order to detect lateral obstacles and also to determine the distance to the obstacles. Such obstacles are displayed on the touchscreen monitor of the input device.

The aircraft itself includes a plurality of operating modes. One operating mode is characterized in that the flight directions of the aircraft are defined by the coordinate system of the remote control. In this case, the X-, Y-, and Z-axes are entered as fixed values in the remote control. The orientation of said coordinate system is specified in the aircraft. In concrete terms, this means that when the remote control is swiveled around the X-axis, i.e. is swiveled toward the front from the pilot's view for example, the helicopter is also piloted in the corresponding direction. This makes it clear that the pilot can always precisely predetermine the direction in which the aircraft should move by moving the remote control.

Differing from this operating mode is a second operating mode in which the flight direction of the aircraft is defined by a coordinate system in the aircraft (First Person View system). In this case, the piloting is done in such a way that the coordinate system of the helicopter defines the flight direction in the X, Y, and Z directions. The alignment of the coordinate system in a helicopter here can be thoroughly different than that in the remote control. In specific terms, this means, for example, that if the remote control is swiveled toward the front, the aircraft, for example, increases its speed in the lateral direction. This means that the orientation of the coordinate system in the aircraft does not change but rather remains fixed just as the coordinate system in the remote control does not change.

### BRIEF DESCRIPTION OF THE DRAWINGS

A further feature of the invention provides that the aircraft have at least one GPS receiver that is connected to the data processing device of the aircraft and/or the remote control. The GPS makes it possible to carry out positioning determination of the helicopter during the flight. A further feature of the invention provides that the remote control have at least one GPS receiver that is connected to the data processing device in the remote control and the helicopter. This makes it possible to carry out positioning determination of aircraft relative to the remote control, i.e. to determine the distance between the aircraft and the remote control, for example.

FIG. 1 schematically shows the three axes of a remote control, the remote control being implemented according to a type of tablet computer;

FIG. 2 schematically shows the aircraft in a view from above;

FIG. 3 shows a side view of the aircraft.

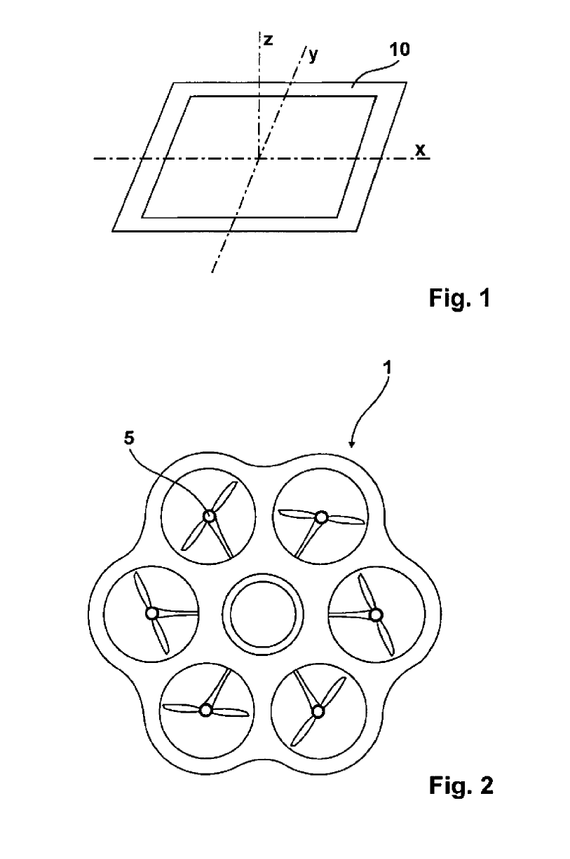

### DETAILED DESCRIPTION

The remote control 10 is advantageously implemented in the form of a tablet computer; i.e., the remote control has a touchscreen monitor, which is used to input data but also to display the image of the camera on the helicopter. The tablet computer has a touchscreen monitor, which means that it is possible to communicate with the aircraft via said touchscreen. In addition, the piloting of the helicopter is implemented through movement of the tablet computer around the three axes of the Cartesian coordinate system, a movement of the tablet computer around the X-axis, for example, effecting a slight movement of the helicopter in the Y direction, the helicopter's speed increasing as the inclination increases. The same thing applies to the movement of the tablet computer around the Y-axis. Thus, it is then possible to effect movements in two spatial directions. A movement of the aircraft around its own axis, i.e. the Z-axis, is implemented in that the tablet computer is also rotated around the Z-axis, the amount of the rotation being correlated with the rotational speed of the helicopter. The ascension altitude and/or the rate of ascent and the rate of descent are input directly via the monitor, in that a brief sliding movement of a finger on the monitor forward/back effects a corresponding, slow upward/downward movement of the aircraft. Long sliding finger movements, on the other hand, effect a quick ascent or descent of the helicopter.

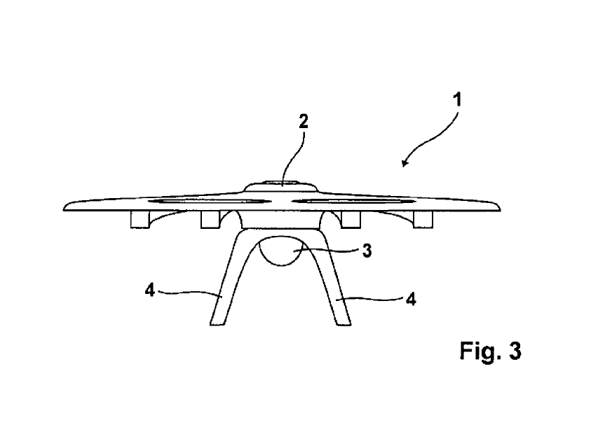

FIG. 3 shows the helicopter in a view from above in which the helicopter has six rotors 5. In the center, the helicopter 1 has an enclosure 2 for accommodating the data processing device, including the flight attitude sensors. The cockpit 3 underneath the helicopter contains, for example, the camera. The batteries for driving the electric motors and also for driving the data processing device as well as the transmitter and receiver are located in the enclosure 2. Furthermore, the helicopter has three legs 4, which are designed in a resilient, flexible manner in order to enable soft landing of the helicopter.

As previously mentioned, both the helicopter and the remote control have multiple, in particular three accelerators and gyroscopes or, in other words, three-axis sensors as gyroscopes and accelerators, the sensors forming an IMU system. Advantageously, it is further provided that the helicopter and also the remote control have a three-axis magnetometer in order to also include the data of the magnetometer for a more precise determination of the orientation of the helicopter. Said flight attitude sensors in this case then form the MARG system.

The piloting of the aircraft then occurs in a form as is shown, for example, below. In this case, an operating mode is set in which the coordinate system in the remote control is dominant for piloting the helicopter.

The tablet computer is tilted, e.g., around the X-axis by a certain amount, for example 15°. If one assumes that the aircraft is already at a certain altitude in the air and uses this as the starting position, then the helicopter will be tilted slightly, which then concretely means that a portion of the motors in the rotors will be restricted, while, on the other hand, the power will be increased in another portion. The result of this is that the helicopter will continue to move perpendicularly with respect to the X-axis of the tablet computer. The respective speed in this direction corresponds to the angular attitude of the tablet computer. The correlations between angle and speed are stored, for example, in the remote control. The same thing occurs with a lateral movement of the tablet computer. In order to rotate the aircraft around its own axis, the tablet computer is likewise rotated around its own axis. The amount of the rotation in this case is the amount of the rotational speed of the aircraft. In order to start and land the aircraft, the procedure is as follows:

The starting speed is defined for the helicopter via the tablet computer by input via the touchscreen monitor. In the same manner, the maximum altitude to which the helicopter can ascend may also be defined.

The situation as to when the helicopter should land is different. As mentioned previously, the helicopter has sensors for determining altitude, particularly an ultrasound sensor and a pressurized air sensor. The ultrasound sensor in this case is provided for determining the altitude at close range, i.e. up to about 10 m, air pressure sensor beyond that determining the altitude. The rate of descent may also be input via the tablet computer, where for safety reasons, however, the rate of descent should not exceed a certain value when a certain minimum altitude is reached in order to prevent destruction of the aircraft when making contact with the ground. The two altitude sensors, the ultrasound sensor, and the pressurized air sensor, function in different altitude ranges, but still overlap one another. This means that if a certain minimum altitude is not reached, the ultrasound sensor is used to determine altitude, while the pressurized air sensor is used to determine greater altitudes. Sensors of this type advantageously also have remote control. This is in order to determine the altitude with the assistance of the pressurized air sensor. Alternatively however, the air pressure may also be determined during the start process and stored.

As previously mentioned, at least two different modes are provided for flight operation. A first mode is characterized, as previously described, in that the orientation of the Cartesian coordinate system of the tablet computer always matches the orientation of the Cartesian coordinate system in the aircraft. This means that when the computer, for example, is rotated around its z-axis, the coordinate system also roams in the aircraft accordingly. However, this also means that a movement of the tablet computer around a certain axis always directly effects a movement of the aircraft in the swivel direction.

A second operating mode is characterized in that the orientation of the Cartesian coordinate system in the aircraft is independent from the orientation of the tablet computer. This means that the orientation of the coordinate system is defined once in the aircraft, the aircraft then optionally conducting a movement in the direction of the X-axis when the tablet computer moves around the X-axis from the view of the pilot at the tablet computer. This operating mode is also known as the “First Person View system.” It may also be provided that the aircraft have at least one GPS receiver. In this case, the position of the aircraft can be determined and displayed on the tablet computer. If the remote control also has a GPS receiver, then positioning determination of the aircraft is also possible relative to the tablet computer. This means that the distance between the aircraft and the tablet computer can be determined.

The aircraft itself has distance sensors on its front which prevent the aircraft from making contact with objects. Distance sensors are implemented as ultrasound or radar sensors and measure the distance between the aircraft and potential obstacles. It is also the case here that the speed is reduced in the direction of the obstacle starting at a certain minimum distance such that a hazard is not possible for the aircraft, even if the aircraft collides with the obstacle.

### REFERENCE LIST

1 Helicopter
2 Enclosure
3 Cockpit
4 Legs
5 Rotors
10 Remote control

1. A flight system comprising:
an aircraft equipped with at least four rotors and having a payload, a number of rotors rotating in one direction and a number of rotors rotating in the other direction; and
a remote control, the aircraft being connected to the remote control so as to transmit data via respective transmitter/receiver units, both the aircraft and the remote control having a data processing device connected to the respective transmitter/receiver unit, both the aircraft and the remote control having the same sensors for flight attitude detection,
where in the event of a change in angle in the remote control around its X-, and/or Y-, and/or Z-axis, the amount of the angle change correlates with a definable speed of the aircraft,
the speed defined according to the angle change being transmitted as the target value of the data processing device of the aircraft and/or the remote control, the actual value of the speed of the aircraft being determined and compared with the target value in the data processing device,
where, by controlling the rotational speed of the rotors, the thrust is modified to such an extent that the target value of the speed matches the actual speed of the aircraft.

2. The flight system according to claim 1, wherein the determination of the target speed of the aircraft over ground is carried out using GPS, radar sensors, or an optical method, such as the optical flow method.

3. The flight system according to claim 1, wherein the data for determining the actual speed of the aircraft is transmitted to the remote control, the data processing device of the remote control calculates the values required for the control for thrust and flight attitude through a target-actual comparison, the calculated thrust and flight attitude values are transmitted to the data processing device of the aircraft, the data processing device of the aircraft converting these specifications for the flight attitude and thrust into the required rotational speeds of the individual rotors.

4. The flight system according to claim 1, wherein the target speed specified according to the angle change in the remote control is transmitted to the data processing device of the aircraft, the control being implemented in the data processing device of the aircraft and modifying the rotational speed of the rotors to the extent that the target value of the speed matches the actual value transmitted.

5. The flight system according to claim 1, wherein the determination of the current rotational speed of the aircraft around the Z-axis is done using flight attitude sensors.

6. The flight system according to claim 1, wherein the data processing device for aligning the aircraft in a horizontal position has a positioning control that is connected to the sensors for flight attitude detection and to the rotors.

7. The flight system according to claim 1, wherein the sensors for flight attitude detection comprise accelerators and/or gyroscopes.

8. The flight system according to claim 7, wherein the aircraft and the remote control contain three accelerators, each of which is aligned in a spatial direction.

9. The flight system according to claim 7, wherein the aircraft and the remote control contain at least one, but preferably three gyroscopes, each of which is allocated to a spatial direction.

10. The flight system according to claim 1, wherein the sensors for flight attitude detection comprise at least one magnetometer.

11. The flight system according to claim 1, wherein the remote control has a touchscreen monitor as an input and display device.

12. The flight system according to claim 11, wherein the rate of ascent and/or descent is pre-definable via the input device.

13. The flight system according to claim 12, wherein the rate of descent of the aircraft does not exceed a pre-definable value starting at a certain altitude.

14. The flight system according to claim 1, wherein the aircraft has sensors for determining altitude (altitude sensors).

15. The flight system according to claim 14, wherein the altitude sensors comprise ultrasound sensors and sensors for determining the air pressure.

16. The flight system according to claim 1, wherein the aircraft has lateral distance sensors.

17. The flight system according to claim 1, wherein the aircraft has a plurality of operating modes.

18. The flight system according to claim 17, wherein in a first operating mode, the flight directions of the aircraft are defined through the coordinate system of the remote control.

19. The flight system according to claim 17, wherein in a second operating mode, the flight directions of the aircraft are defined through a coordinate system in the aircraft (First Person View system).

20. The flight system according to claim 1, wherein the aircraft has at least one GPS receiver, which is connected to the data processing device of the aircraft and/or the remote control.

21. The flight system according to claim 1, wherein the remote control has at least one GPS receiver, which is connected to the data processing device of the remote control.
